(19) United States
(12) Patent Application Publication
(10) Pub. No.: US 2025/0379544 A1
(43) Pub. Date: Dec. 11, 2025

(54) SOLAR PANEL SNOW REMOVAL SYSTEM

(71) Applicants: Alexander L'Amie, Grand Rapids, MN (US); Jim Mahon, Cohasset, MN (US)

(72) Inventors: Alexander L'Amie, Grand Rapids, MN (US); Jim Mahon, Cohasset, MN (US)

(21) Appl. No.: 19/229,172

(22) Filed: Jun. 5, 2025

Related U.S. Application Data
(60) Provisional application No. 63/656,466, filed on Jun. 5, 2024.

(51) Int. Cl. H02S 40/12; H02S 30/10; H02S 50/00

(52) U.S. Cl. CPC H02S 40/12; H02S 30/10; H02S 50/00

(57) ABSTRACT

This disclosure pertains to snow removal systems, specifically systems designed to maintain the functional efficiency of solar panels by preventing the accumulation of snow on solar panels. Solar panels are devices that convert light into electricity and are commonly used in a variety of settings, from residential rooftops to large-scale solar farms. These panels consist of multiple solar cells made from semiconductor materials that exhibit the photovoltaic effect. The efficiency of solar panels is contingent upon their exposure to sunlight, which can be impeded by environmental factors such as the accumulation of snow. The technical background involves mechanisms and methods for preserving the optimal operational state of solar panels in environments subject to snowfall.

### CROSS-REFERENCE TO RELATED PATENT APPLICATIONS

This application claims the benefit of U.S. Provisional Patent Application No. 63/656,466, filed Jun. 5, 2024, the entire content and disclosure of which is incorporated herein by reference and for all purposes.

### FIELD

The following disclosure relates to snow removal systems, and more particularly, to solar panel snow removal systems and methods for preventing the accumulation of snow on solar panels.

### BACKGROUND

Solar panels are devices that convert light into electricity and are commonly used in a variety of settings, from residential rooftops to large-scale solar farms. These panels are typically exposed to the environment and, as such, are subject to various weather conditions that can affect their performance and efficiency. The accumulation of snow on solar panels is a particular concern in colder climates, as it can obstruct sunlight and reduce the electrical output of the panels. Existing solutions for snow removal from solar panels include manual cleaning and passive heating methods, but these can be labor-intensive, energy-consuming, and not always effective or feasible, especially for large installations or in areas with frequent snowfall.

### SUMMARY

The present disclosure provides snow removal systems and methods for preventing the accumulation of snow on solar panels. A first aspect of the present disclosure provides a snow removal system for removing snow from a solar panel having solar cells arrangeable to receive solar energy to generate electricity. The snow removal system includes a solar panel covering configured to be mounted to the solar panel and configured to move relative to the solar panel to reveal and cover the solar cells.

In some embodiments, the snow removal system may further include a frame attached to the solar panel covering and configured to be mounted to the solar panel. In some embodiments, the frame may include a roller assembly adapted to have the solar panel covering rolled onto, to expose the solar panel in an exposed configuration, and rolled off of, to cover the solar panel in a covered configuration. In other embodiments, the frame may include an actuator assembly adapted to rotate the solar panel covering to expose the solar cells in an exposed configuration and to rotate the solar panel covering to cover the solar cells in a covered configuration.

In some embodiments, the snow removal system may further include a motor coupled to the solar panel covering for driving rotation of the solar panel covering. In some embodiments, the snow removal system may further include a controller operatively connected to the motor. In some embodiments, the snow removal system may further include a pressure sensor operatively connected to the controller. In some embodiments, the snow removal system may further include a communication module configured to provide a pressure reading from the pressure sensor. In some embodiments, the pressure reading may correspond to the amount of snow that has accumulated on the solar panel. While in other embodiments, the pressure reading may correspond to the amount of snow that has accumulated on the solar panel covering.

In some embodiments, the roller assembly may further include a first roller configured to be mounted to a first end of the solar panel. In some embodiments, the roller assembly may further include a second roller configured to be mounted to a second end of the solar panel that is opposite the first end of the solar panel. In some embodiments, the solar panel covering may extend from the first roller to the second roller while the snow removal system is, thereby blocking a surface of the solar panel from an accumulation of snow in a covered configuration. In some embodiments, the solar panel covering is rolled onto at least one of the first or second rollers, thereby exposing a surface of the solar panel to the sun in the exposed configuration.

In some embodiments, the controller may automatically change the configuration of the snow removal system from a covered configuration to an exposed configuration or from an exposed configuration to a covered configuration based on one or more parameters received by the controller. In some embodiments, the one or more parameters includes a pressure reading from the pressure sensor. In some embodiments, the one or more parameters includes a voltage reading from the solar panel.

In some embodiments, the snow removal system may further include a temperature sensor operatively connected to the controller. In some embodiments the communication module is configured to provide a temperature reading corresponding to a temperature of a surface of the solar panel. In some embodiments the communication module is configured to provide a temperature reading corresponding to a temperature of a surface of the solar panel covering.

In some embodiments, the one or more parameters includes a temperature reading from the temperature sensor. In some embodiments, the solar panel covering is formed from a non-stick material, such that an amount of snow falling on the solar panel covering is inhibited from adhering to the solar panel covering. In some embodiments, the snow removal system may further include an incline adjustment assembly capable of adjusting an angle of the solar panel covering relative to the solar panel, so as to cause an amount of snow accumulating on the solar panel covering to fall off the solar panel covering.

In some embodiments, the incline adjustment assembly includes a drive system movably connected to the frame. In some embodiments, the incline adjustment assembly further includes a lift motor operably connected to the drive system. In some embodiments, activation of the lift motor adjusts the position of the drive system to vary the angle of the solar panel covering relative to the solar panel. In some embodiments, the communication module is a wireless communication module configured to connect to an external device, so as to provide information from the controller to a user. In some embodiments, the solar panel covering is formed from a transparent material, such that in the covered configuration, the solar panel covering allows an amount of sunlight to reach the solar cells of the solar panel while preventing an accumulation of snow on the solar panels.

A second aspect of the present disclosure provides a method of removing snow from a solar panel having solar cells arrangeable to receive solar energy to generate electricity. The method includes covering the solar cells of the solar panel with a solar panel covering, such that an amount of snow falling on the solar panel covering is inhibited from adhering to the solar panel covering in a covered configuration. In some embodiments, the method may further include moving the solar panel covering away from the solar cells of the solar panel, such that the solar cells are exposed to solar energy to generate electricity in an exposed configuration.

In some embodiments, the method may further include automatically changing the configuration of the snow removal system from a covered configuration to an exposed configuration or from an exposed configuration to a covered configuration based on one or more parameters received by a controller. In some embodiments, the method may further include providing information received by a controller operably connected to the snow removal system to a user through a wireless communication module configured to connect to an external device.

While multiple embodiments are disclosed, still other embodiments of the present disclosure will become apparent to those skilled in the art from the following detailed description, which shows and describes illustrative embodiments of the disclosure. Accordingly, the drawings and detailed description are to be regarded as illustrative in nature and not restrictive.

### BRIEF DESCRIPTION OF THE DRAWINGS

FIG. 1 illustrates a perspective view of a solar panel comprising a plurality of solar cells, in accordance with embodiments of the present disclosure;

FIG. 2 illustrates a perspective view of a snow removal system comprising a frame and a roller assembly, in accordance with embodiments of the present disclosure;

FIG. 3 illustrates a perspective view of the snow removal system of FIG. 2 installed on the solar panel of FIG. 1, in accordance with embodiments of the present disclosure;

FIG. 4 illustrates a perspective view of the snow removal system and solar panel of FIG. 3 with the solar panel covering in a partially covered configuration, in accordance with embodiments of the present disclosure;

FIG. 5 is a side elevation drawing of a roller assembly of the snow removal system, including an arrow to depict the manner in which the solar panel covering is retracted onto the roller, in accordance with embodiments of the present disclosure;

FIG. 6 is a side elevation drawing of another roller assembly of the snow removal system, including an arrow to depict the manner in which the solar panel covering is moved to the back of the snow removal system, in accordance with embodiments of the present disclosure; and

FIG. 7 is a flowchart showing a process for operating a snow removal system, in accordance with embodiments of the present disclosure.

While the disclosed subject matter is amenable to various modifications and alternative forms, specific embodiments have been shown by way of example in the drawings and are described in detail below. The intention, however, is not to limit the disclosure to the particular embodiments described. On the contrary, the disclosure is intended to cover all modifications, equivalents, and alternatives falling within the scope of the disclosure as defined by the appended claims.

### DETAILED DESCRIPTION

Within the technical field of solar panel maintenance, the primary challenge addressed by this disclosure is the efficient and automatic removal of snow without the need for manual intervention or significant energy expenditure. Maintaining clear solar panel surfaces is crucial for maximum energy conversion efficiency. Traditional approaches to this problem have included manual brushing or scraping, which is laborious and potentially damaging to the panels. Automated heating systems have also been used to melt snow, but these may be prohibitively expensive and environmentally unfriendly due to the high energy costs associated with heating large surface areas. These methods may not be effective in all snow conditions and may pose a risk of damaging the solar panels, especially in remote or large-scale solar installations.

The disclosed invention provides a novel snow removal system designed specifically for solar panels. The system includes a solar panel covering that can rotate about a longitudinal axis, a frame that is fixedly attached to the solar panel covering and removably attached to the solar panel, and a motor that drives the rotation of the covering. The system is further enhanced by a controller that operates the motor and is connected to various sensors, such as pressure and temperature sensors, to determine the optimal times for snow removal based on environmental conditions.

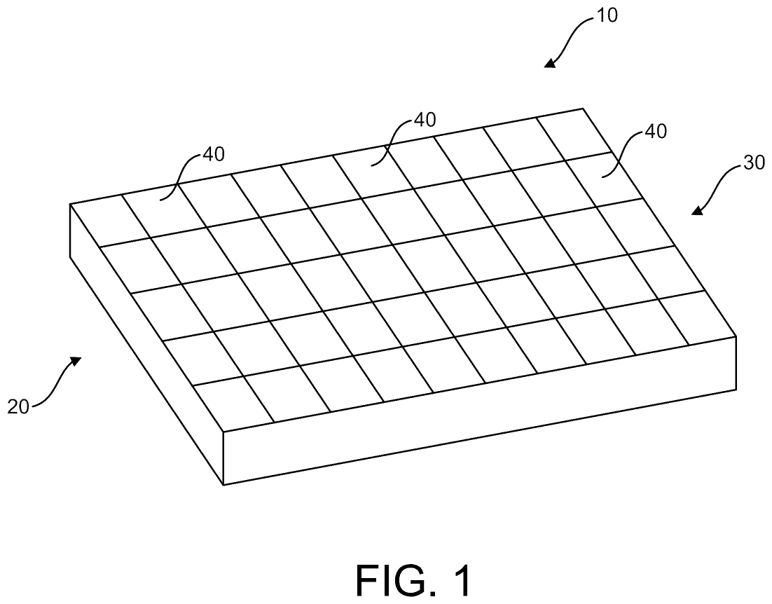

Referring to FIG. 1, a solar panel comprising a plurality of solar cells is shown. Solar panel 10 includes a plurality of solar cells 40 spanning from a first end 20 of solar panel 10 to a second end 30 that is opposite the first end 20. Solar cells 40 absorb sunlight and convert that sunlight into electricity.

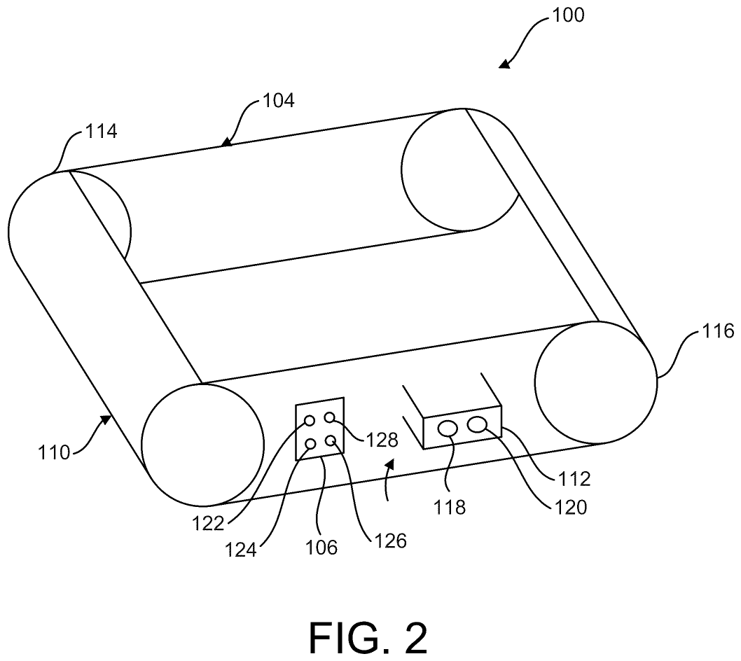

An exemplary snow removal system 100 is shown in FIG. 2. Snow removal system 100 includes solar panel covering 102 movably attached to frame 104 and control module 106 operably connected to frame 104. Solar panel covering 102 is designed to rest on, or hover over, a surface of solar panel 10 and is configured to roll onto and off of the surface of solar panel 10, exposing or covering solar cells 40 as needed. In a covered configuration, solar panel covering 102 rests on, or hover over, a surface of solar panel 10, covering solar cells 40 of solar panel 10. In an exposed configuration, solar panel covering 102 is moved away from the surface of solar panel 10, exposing solar cells 40 of solar panel 10. Frame 104 provides a rigid support for components of snow removal system 100 and attaches to solar panel 10 to allow solar panel covering 102 to rest on, or hover over, the surface of solar panel 10 in the covered configuration. Control module 106 controls the operation of snow removal system 100 and provides an interface for communication between a user and the system.

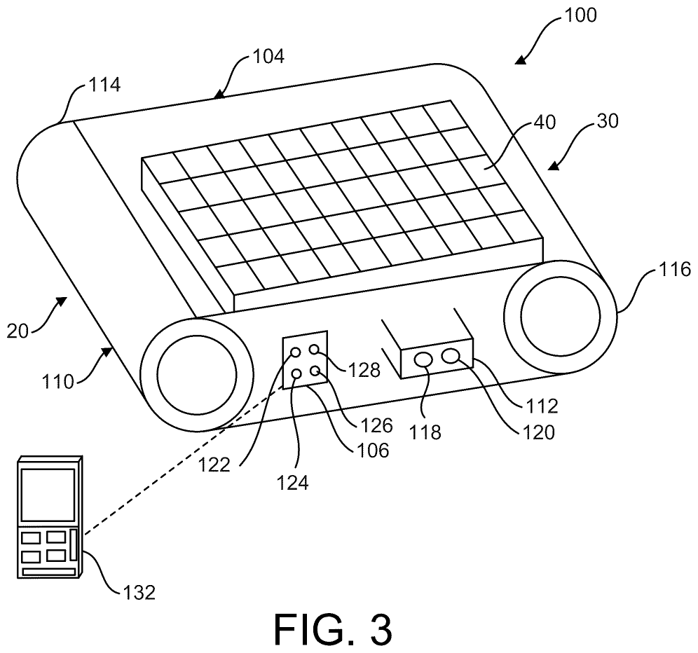

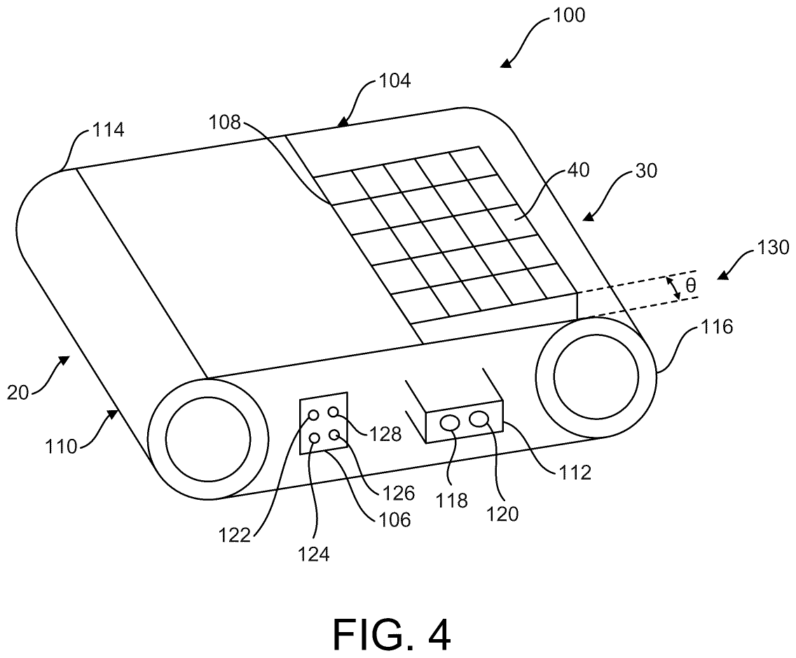

FIG. 4 shows the snow removal system 100 of FIG. 3 in a partially covered configuration, where solar cells 40 of solar panel 10 are partially covered by solar panel covering 102. As illustrated, leading edge 108 of solar panel covering 102 moves along the surface of solar panel 10 from the first end 20 of solar panel 10 to the second end 30 of solar panel 10. In an exposed configuration, leading edge 108 of solar panel covering 102 is positioned at, or around, the first end 20 of solar panel 10, thereby exposing solar cells 40 of solar panel 10 to sunlight. In a covered configuration, leading edge 108 of solar panel covering 102 is positioned at, or around, the second end 30 of solar panel 10, thereby blocking solar cells 40 of solar panel 10 from sunlight. In some embodiments, the solar panel covering may be created from an opaque material that, in a covered configuration, prevents the passage of sunlight to the solar cells. In other embodiments, the solar panel covering may be created from a transparent or translucent material that allows an amount of sunlight to pass through the covering into the solar cells even in a covered configuration.

FIG. 4 shows frame 104 and control module 106 of snow removal system 100. Control module 106 includes processor 122 operably connected to pressure sensor 124 and temperature sensor 126. Pressure sensor 124 monitors the pressure on a surface of snow removal system 100, while temperature sensor 126 monitors the temperature of a surface of snow removal system 100. In some embodiments, pressure sensor 124 may instead monitor the pressure on a surface of solar panel 10, while temperature sensor 126 monitors the temperature of a surface of solar panel 10.

Control module 106 further includes processor 122 which processes inputs from pressure sensor 124 and temperature sensor 126 to make automated decisions about when to remove snow. This automation is based on a set of parameters that may include the amount of snow accumulated, as measured by a sensor in a sensor assembly, such as pressure sensor 124, and the temperature of solar panel 10 or solar panel covering 102, as measured by another sensor in the sensor assembly, such as temperature sensor 126. Processor 122 can also receive voltage readings from solar panel 10 to assess the impact of snow coverage on electrical output. Processor 122 receives pressure and temperature measurements from the sensors and uses these sensor readings to control snow removal system 100, such as switching snow removal system 100 from an exposed configuration to a covered configuration or vice versa.

Control module 106 further includes communication module 128 which provides a user interface for a user to interact with snow removal system 100. In some embodiments, processor 122 may automatically change the configuration of snow removal system 100 based on inputs from pressure sensor 124 and temperature sensor 126. In some embodiments, communication module 128 may wirelessly connect to an external device 132, such as a cellular phone to allow for remote monitoring and control, while providing users with the ability to receive updates and adjust settings from the external device 132.

In some embodiments, frame 104 of snow removal system 100 may further include incline adjustment assembly 112 which adjusts the incline angle 130 of solar panel covering 102 relative to the solar panel 10. This feature allows snow to fall off the covering more easily, especially when the covering is made of a non-stick material. Incline adjustment assembly 112 comprises drive system 118 and lift motor 120, which work together to change the angle of solar panel covering 102. Incline adjustment assembly 112 is operably connected to frame 104, such that incline adjustment assembly 112 moves frame 104 and solar panel covering 102 relative to solar panel 10. In effect, incline adjustment assembly 112 changes the tilt angle of solar panel covering 102 to remove an accumulation of snow from the surface of solar panel covering 102. Incline adjustment assembly 112 includes lift motor 120 operably connected to frame 104 through drive system 118. Lift motor 120 moves an edge of frame 104 upwards or downwards, such that the tilt angle of solar panel covering 102 increases or decreases. Lift Motor 120 must provide enough force to adjust the angle of the solar panel covering and may include an actuator with specifications tailored to the weight and resistance of drive system 118 and solar panel covering 102. Processor 122 activates lift motor 120 based on inputs from sensors, such as pressure sensor 124 and temperature sensor 126, and from remote commands to adjust incline angle 130 of solar panel covering 102 relative to solar panel 10.

Drive system 118 may include a series of mechanical arms, rods, and joints that translate the motion from lift motor 120 to adjust incline angle 130 of solar panel covering 102 relative to solar panel 10. Drive system 118 is designed to ensure stability and even distribution of force to prevent warping or damage to solar panel covering 102.

Frame 104 further comprises roller assembly 110 which facilitates the rolling action that allows solar panel covering 102 to move between the covered and exposed configurations. Roller assembly 110 allows snow removal system 100 to switch configurations by moving solar panel covering 102 to cover solar cells 40 in a covered configuration and moving solar panel covering 102 to expose solar cells 40 in an exposed configuration.

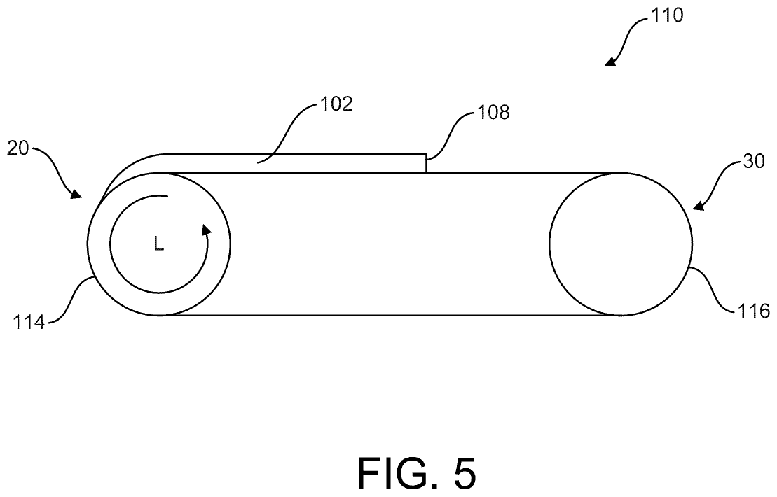

Referring now to FIG. 5, roller assembly 110 includes motor 113, first roller 114, and second roller 116. Motor 113, first roller 114, and second roller 116 cooperate to move leading edge 108 of solar panel covering 102 along a surface of solar panel 10. Motor 113 drives the rotation of one, or both, of first roller 114 and second roller 116. Motor 113 is may be a low-voltage electric motor, such as a stepper motor which allows for precise control of the rotation, or a DC motor which allows for simpler control. Motor 113 is preferably selected to provide sufficient torque to rotate the solar panel covering, which may have significant weight, especially when laden with snow. In some embodiments, motor 113 includes an adjustable speed control to control the rate of covering or exposing of solar panel 10 to prevent damage to solar panel covering 102 by ensuring that the operation is smooth. In some embodiments, motor 113 is powered by electricity generated by solar panel 10 and may include a backup battery to ensure functionality during periods without sunlight. In other embodiments, motor 113 may be powered by an alternative source of energy, such as electricity sourced from the public electricity grid. Given that motor 113 may be exposed to outdoor conditions, motor 113 preferably includes a suitable ingress protection rating to avoid damage from moisture and debris. By rotating in a clockwise direction, first roller 114 pulls solar panel covering 102, thereby causing solar panel covering 102 to wrap onto first roller 114 in a covered configuration, as shown by the arrow L. By rotating in a counterclockwise direction, first roller 114 moves solar panel covering 102, thereby causing solar panel covering 102 to wrap onto first roller 114 in a covered configuration. In some embodiments, solar panel covering 102 wraps onto second roller 116 in a covered configuration, and second roller 116 rotates in a counterclockwise direction to push the leading edge 108 of solar panel covering 102 away from second roller 116 and towards first roller 114, thereby unwrapping solar panel covering 102 from second roller 116 and exposing solar cells 40 in an exposed configuration.

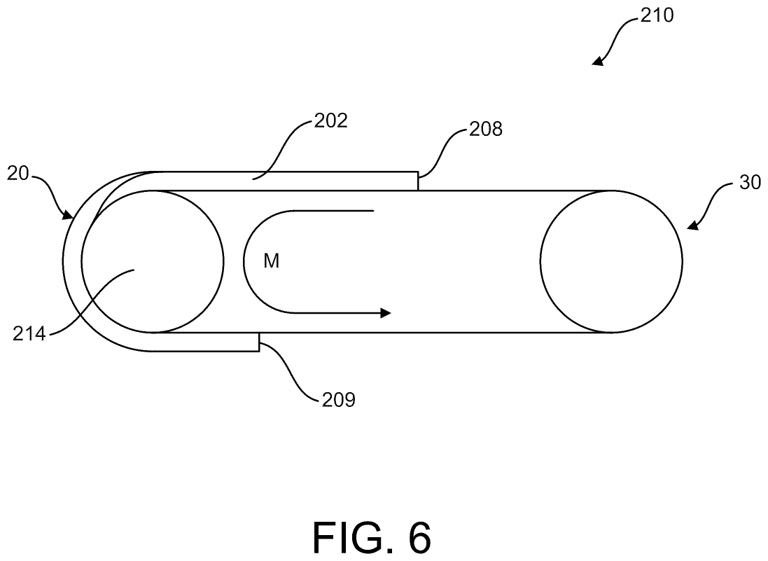

Referring to FIG. 6, another embodiment of roller assembly 210 is shown. Roller assembly 210 includes actuating device 214 which moves solar panel covering 202 back and forth between the front surface of frame 204, where solar cells 40 are blocked from receiving sunlight by solar panel covering 202, and the back surface of frame 204, where solar cells 40 are exposed, as shown by the arrow M. In some embodiments, solar panel covering 202 includes a first edge 208 and a second edge 209 that it opposite the first edge 208. When transitioning from a covered configuration to an exposed configuration, first edge 208 moves along a top surface of frame 204 from the second end 30 of solar panel 10 to the first end 20 of solar panel 10. Meanwhile, second edge 209 moves along a bottom surface of frame 204 from a first end 20 of solar panel 10 to a second end 30 of solar panel 10. Conversely, when transitioning from an exposed configuration to a covered configuration, first edge 208 moves along the top surface of frame 204 from the first end 20 of solar panel 10 to the second end 30 of solar panel 10. Accordingly, second edge 209 moves along the bottom surface of frame 204 from the second end 30 of solar panel 10 to the first end 20 of solar panel 10.

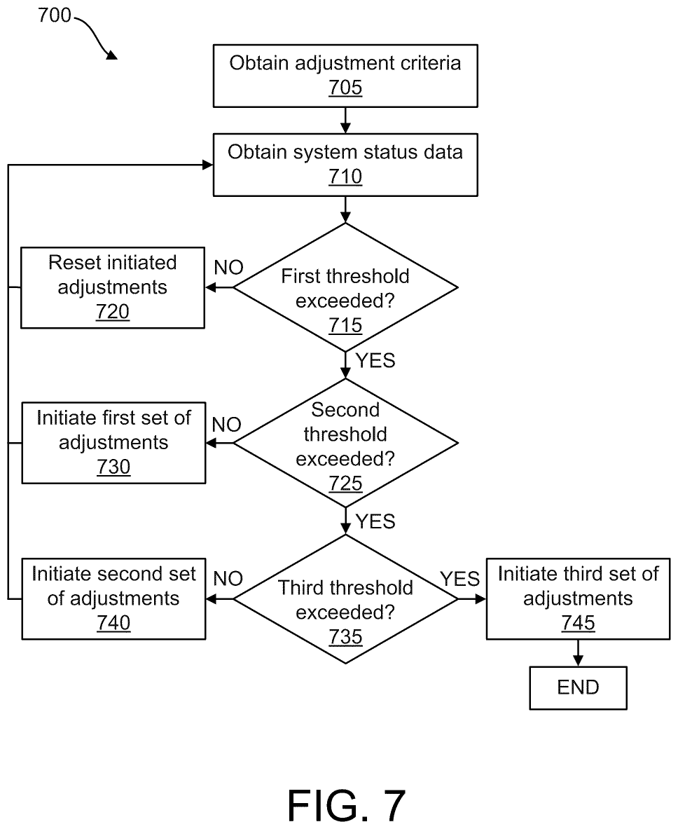

FIG. 7 illustrates a flowchart of an example method 700 for removing snow from a solar panel, in accordance with embodiments of the present disclosure. Method 700 can be performed automatically (e.g., autonomously) by snow removal system 100 or can be manually performed by a user.

Referring back to FIG. 7, in operation 705, the snow removal system obtains adjustment criteria. Adjustment criteria can include data corresponding to one or more adjustments, or changes, that can be made to the system. For example, in some embodiments, such a adjustment can include changing a configuration of the snow removal system from a covered configuration to an exposed configuration. In some embodiments, such a adjustment can include changing a tilt angle between the solar panel and the solar panel covering. In some embodiments, adjustment criteria can include one or more instructions for the snow removal system to initiate one or more respective adjustments to the system.

In some embodiments, adjustment criteria can include sets of adjustments, such sets of adjustments can correspond to thresholds, such as solar panel thresholds, as discussed below. In some embodiments, the adjustment criteria can include first, second, and third thresholds corresponding, respectively, to the first, second, and third sets of adjustments. For example, the first set of adjustments can correspond to a first temperature threshold of approximately 75° C. to approximately 85° C. In this example, for a case in which a solar panel temperature exceeds the first temperature threshold, the snow removal system can initiate one or more adjustments of the first set of adjustments to the system. Additionally in this example, for a case in which the solar panel temperature exceeds the second temperature threshold (e.g., approximately 120° C. to approximately 150° C.), the snow removal system can initiate one or more adjustments of the second set of adjustments to the system. Additionally in this example, for a case in which the solar panel temperature exceeds the third pressure threshold (e.g., approximately 10 KPa), the snow removal system can initiate one or more adjustments of the third set of adjustments to the system. These thresholds can be higher or lower and will vary based on a given implementation. As such, the specific numbers should not be construed as strictly limiting the scope of this disclosure.

In some embodiments, initiating an adjustment can include the snow removal system transmitting an instruction/command to the system control module to perform the adjustment. In some embodiments, initiating a adjustment can include the snow removal system transmitting an instruction/command to a system subsystem to perform the adjustment. In some embodiments, initiating a adjustment can include the snow removal system transmitting a notification (e.g., displaying a message on a user interface) such that a user (e.g., a system operator) can perform the adjustment.

In some embodiments, the adjustment criteria can be selected by an entity, such as a programmer of the snow removal system, and stored in memory of a computing device, such as a computing device of a system control module of the system.

Referring back to FIG. 7, in operation 710, the snow removal system obtains system status data. System status data can include information about the operation and/or activity of the system. For example, in some embodiments, system status data can include information such as solar panel configuration data indicating a configuration of the solar panel and the incline angle 130 of the solar panel covering relative to the solar panel. In some embodiments, the snow removal system can obtain solar panel temperature from a virtual sensor, such as a model, or computer algorithm, configured to approximate a temperature of a power supply based on information about the system. In some embodiments, the snow removal system can obtain solar panel temperature from physical sensors of the system.

In operation 715, the snow removal system determines, by comparing the solar panel configuration data to the first threshold, whether the solar panel configuration data exceeds the first threshold. In response to determining that the first threshold is exceeded, the snow removal system proceeds to operation 725. Alternatively, in response to determining that the first threshold is not exceeded, the snow removal system proceeds to operation 720. In operation 720, the snow removal system can reset (e.g., return to an initial state) any adjustments previously initiated by the snow removal system.

In operation 725, the snow removal system determines, by comparing the solar panel configuration data to the second threshold, whether the solar panel configuration data exceeds the second threshold. In response to determining that the second threshold is exceeded, the snow removal system proceeds to operation 735. Alternatively, in response to determining that the first threshold is not exceeded, the snow removal system proceeds to operation 730, where it initiates one or more of the first set of adjustments.

In operation 735, the snow removal system determines, by comparing the solar panel temperature to the third threshold, whether the solar panel temperature exceeds the third threshold. In response to determining that the third threshold is exceeded, the snow removal system proceeds to operation 745, where it initiates one or more of the third set of adjustments. Alternatively, in response to determining that the third threshold is not exceeded, the snow removal system proceeds to operation 740, where it initiates one or more of the second set of adjustments.

To further illustrate embodiments of the present disclosure, the following is an example performance of method 700 by the snow removal system. In operation 705, the snow removal system can obtain adjustment criteria from a data storage device, such as a memory of a computing device of the system's system control module. The adjustment criteria can include instructions to initiate a first set of adjustments to the system in response to solar panel temperature indicating that the temperature of the system exceeds (i.e., is greater than) a first threshold of 80° C. The adjustment criteria can further include instructions to initiate a second set of adjustments to the system in response to the solar panel temperature indicating that the temperature of the system exceeds a second threshold of 150° C. The adjustment criteria can further include instructions to initiate a third set of adjustments to the system in response to the solar panel temperature indicating that the pressure on the system exceeds a third threshold of 10 KPa. In this example, snow removal system 100 begins in a covered configuration where solar panel covering 102 covers a surface of solar panel 10, thereby blocking solar cells 40 from direct sunlight. However, it is contemplated within the scope of this disclosure that a method of operation may begin with snow removal system 100 beginning in an exposed configuration.

Continuing with this example, in operation 710, the snow removal system obtains a temperature reading corresponding to the temperature of solar panel 10 from a temperature sensor, such as temperature sensor 126. Additionally, in operation 715, processor 122 determines whether the temperature of solar panel 10 is greater than a first threshold. The first threshold is selected such that a temperature exceeding this threshold is indicative of the presence of sunlight. In some embodiments, the temperature reading may correspond to the temperature of the solar panel covering, which is also positively correlated to the amount of sunlight reaching snow removal system 100.

If the temperature of solar panel 10 does not exceed the first threshold, the method proceeds to operation 720. In operation 720, snow removal system 100 determines whether a pressure reading, corresponding to an amount of snow accumulated on solar panel covering 102, exceeds a second threshold. The second threshold is selected such that a pressure reading exceeding this threshold is indicative of a significant amount of snow accumulating on solar panel covering 102. What constitutes a significant amount of snow depends on several factors, including the amount of snowfall expected in a geographical area, the durability of materials used to construct snow removal system 100 and solar panel 10, and the preferences of a user. If the pressure reading does not exceed the second threshold, the method ends proceeds to operation 730, however, if the pressure reading exceeds this threshold, the method proceeds to operation 735. In operation 735, incline adjustment assembly 112 increases the incline angle 130 of solar panel covering 102 relative to solar panel 10, such that the snow that has accumulated on snow removal system 100 falls off solar panel covering 102.

Continuing with this example, if processor 122 determines that the temperature of solar panel 10 exceeds the first threshold, the method moves to operation 725. In operation 725, snow removal system 100 is put into an exposed configuration where solar panel covering 102 is moved away from the surface of solar panel 10, thereby exposing solar cells 40. Next, the method moves to operation 735 where snow removal system 100 determines whether a pressure reading, corresponding to an amount of snow accumulated on solar panel 10, exceeds a third threshold. The third threshold is selected such that a pressure reading exceeding this threshold is indicative of a significant amount of snow accumulating on solar panel 10. A pressure reading exceeding this threshold signals that snow removal system 100 must be put in a covered configuration to prevent additional snow from accumulating on solar panel 10. If processor 122 determines that the pressure reading exceeds the third threshold, the method proceeds to operation 745. In operation 745, snow removal system 100 is put into a covered configuration where solar panel covering 102 rests on, or hover over, the surface of solar panel 10, thereby blocking solar panel 10 from receiving additional snow accumulation. However, if processor 122 determines that the pressure reading does not exceed the third threshold, the method proceeds to operation 740. In operation 740, snow removal system 100 is put into an exposed configuration where solar panel covering 102 is moved away from the surface of solar panel 10, thereby exposing solar cells 40.

It is well understood that methods that include one or more steps, the order listed is not a limitation of the claim unless there are explicit or implicit statements to the contrary in the specification or claim itself. It is also well settled that the illustrated methods are just some examples of many examples disclosed, and certain steps can be added or omitted without departing from the scope of this disclosure. Such steps can include incorporating devices, systems, or methods or components thereof as well as what is well understood, routine, and conventional in the art. It should be noted that many alternative or additional functional relationships or physical connections can be present in a practical system. However, the benefits, advantages, solutions to problems, and any elements that can cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone can be present in an embodiment, B alone can be present in an embodiment, C alone can be present in an embodiment, or that any combination of the elements A, B or C can be present in a single embodiment; for example, A and B, A and C, B and C, or A and B and C.

In the detailed description herein, references to “one embodiment,” “an embodiment,” “an example embodiment,” etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but can include other elements not expressly listed or inherent to such process, method, article, or apparatus.

While various embodiments of the disclosure have been shown and described, it is understood that these embodiments are not limited thereto. The embodiments may be changed, modified and further applied by those skilled in the art. Therefore, these embodiments are not limited to the detail shown and described previously, but also include all such changes and modifications.

What is claimed is:

1. A snow removal system for removing snow from a solar panel having solar cells arrangeable to receive solar energy to generate electricity, the snow removal system comprising a solar panel covering configured to be mounted to the solar panel and configured to move relative to the solar panel to reveal and cover the solar cells.

2. The snow removal system of claim 1, further comprising a frame attached to the solar panel covering and configured to be mounted to the solar panel, the frame having a roller assembly adapted to have the solar panel covering spooled thereby exposing the solar panel in an exposed configuration and unrolled from to thereby covering the solar panel in a covered configuration.

3. The snow removal system of claim 1, further comprising a frame attached to the solar panel covering and configured to be mounted to the solar panel, the frame having an actuator assembly adapted to move the solar panel covering to an underside of the solar panel to expose the solar cells in an exposed configuration, and to move the solar panel covering to cover the solar cells in a covered configuration.

4. The snow removal system of claim 1, further comprising a motor coupled to the solar panel covering for driving rotation of the roller to move the solar panel covering.

5. The snow removal system of claim 4, further comprising:
a controller operatively connected to the motor;
a sensor assembly operatively connected to the controller; and
a communication module configured to provide a pressure reading from the sensor assembly corresponding to at least one of:
an amount of snow accumulated on the solar panel; and
an amount of snow accumulated on the solar panel covering.

6. The snow removal system of claim 2, wherein the roller assembly further comprises a first roller configured to be mounted to a first end of the solar panel and a second roller configured to be mounted to a second end of the solar panel that is opposite the first end of the solar panel, wherein in a covered configuration, the solar panel covering extends from the first roller to the second roller, thereby blocking a surface of the solar panel from an accumulation of snow, and in an exposed configuration, the solar panel covering is rolled onto at least one of the first or second rollers, thereby exposing a surface of the solar panel to the sun.

7. The snow removal system of claim 4, wherein based on one or more parameters received by the controller, the controller automatically changes a configuration of the snow removal system from a covered configuration to an exposed configuration or from an exposed configuration to a covered configuration.

8. The snow removal system of claim 7, wherein the one or more parameters that corresponds to a pressure reading from the sensor assembly.

9. The snow removal system of claim 8, wherein the one or more parameters corresponds to a voltage reading from the solar panel to determine whether or not sunlight is reaching a solar cell.

10. The snow removal system of claim 5, further comprising a temperature sensor operatively connected to the controller, wherein the communication module is configured to provide a temperature reading corresponding to at least one of:
a temperature of a surface of the solar panel; and
a temperature of a surface of the solar panel covering.

11. The snow removal system of claim 10, wherein the one or more parameters corresponds to a temperature reading from the temperature sensor.

12. The snow removal system of claim 1, wherein the solar panel covering comprises a non-stick material, such that an amount of snow falling on the solar panel covering is inhibited from adhering to the solar panel covering.

13. The snow removal system of claim 1, further comprising an incline adjustment assembly capable of adjusting an angle of the solar panel covering relative to the solar panel, so as to cause an amount of snow accumulating on the solar panel covering to fall off the solar panel covering.

14. The snow removal system of claim 13, wherein the incline adjustment assembly comprises:
a drive system movably connected to the frame; and
a lift motor operably connected to the drive system;
wherein activation of the lift motor adjusts the position of the drive system to vary the angle of the solar panel covering relative to the solar panel.

15. The snow removal system of claim 5, wherein the communication module is a wireless communication module configured to connect to an external device, so as to provide operational information from the controller to a user.

16. A method of removing snow from a solar panel having solar cells arrangeable to receive solar energy to generate electricity, the method comprising the steps of:
covering the solar cells of the solar panel with a solar panel covering in a covered configuration, such that an amount of snow falling on the solar panel covering is inhibited from adhering to the solar panel covering; and
moving the solar panel covering away from the solar cells of the solar panel in an exposed configuration, such that the solar cells are exposed to solar energy to generate electricity.

17. The method of claim 16, further comprising the steps of automatically changing the configuration of the snow removal system from a covered configuration to an exposed configuration or from an exposed configuration to a covered configuration based on one or more parameters received by a controller.

18. The method of claim 16, further comprising the step of providing information from the controller operably connected to the snow removal system, wherein the information is provided to a user through a wireless communication module configured to connect to an external device.

19. The method of claim 17, wherein the one or more parameters corresponds to at least one of a pressure reading from a pressure sensor and a temperature reading from a temperature sensor, the pressure reading corresponding to one of:
an amount of snow accumulated on the solar panel; and
an amount of snow accumulated on the solar panel covering; and
the temperature reading corresponding to one of:
a temperature of a surface of the solar panel; and
a temperature of a surface of the solar panel covering.

20. The snow removal system of claim 1, wherein the solar panel covering is formed from a transparent material, such that in the covered configuration, the solar panel covering allows an amount of sunlight to reach the solar cells of the solar panel while preventing an accumulation of snow on the solar panels.
